(19) United States
(12) Patent Application Publication
(10) Pub. No.: US 2009/0080003 A1
(43) Pub. Date: Mar. 26, 2009

(54) IMAGE FORMING APPARATUS HAVING THINNING FUNCTION AND THE THINNING METHOD

(75) Inventor: Naoya Murakami, Yokohama-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/859,917

(22) Filed: Sep. 24, 2007

(51) Int. Cl. G06F 19/00

(52) U.S. Cl. 358/1.9

(57) ABSTRACT

An image forming apparatus includes an image area identification unit to discriminate a character area and a line drawing area from an image area with respect to an image formed based on inputted color image data, an edge detection unit to detect an edge of a character and a line drawing, which is identified, and an edge γ correction unit to perform, only in a case where the edge exists on a white ground area in the image, thinning to lower an image density of a pixel on an outer border corresponding to the edge on the white ground area.

### BACKGROUND OF THE INVENTION

1. Field of the Invention

The present invention relates to an image forming apparatus having a thinning function in which an edge of a character and line drawing portion is extracted from inputted image data and which is performed according to a ground area, and the thinning method.

2. Description of the Related Art

As an electronic equipment or a communication equipment in office automation in recent years, a copying apparatus, a facsimile apparatus, a printer apparatus or the like has been introduced. With respect to these equipments, from the use's demand for a reduction in floor area and a reduction in power consumption, the introduction of a compound image forming apparatus (multi-facsimile-printer apparatus: hereinafter referred to as an MFP apparatus) in which plural functions, such as facsimile function, copy function and printer function, are integrally mounted is required. In response to this request, a technique to improve the function of the MFP apparatus and to speed up the processing is rapidly developed, and the shift to colorization, that is, the shift from a monochrome MFP apparatus to a color MFP apparatus is made. With the advance of the technique, the amount of consumption of toner used in the color recording is increased, and importance is attached to a technique of reducing the amount of consumption of toner from the viewpoint of reduction of cost.

In the related art monochrome recording technique, there is known a technique to suppress the amount of consumption of toner by simply thinning the line width of a character. When this technique is applied to color recording, in the case where a recording medium has a white ground (that is, in the case where ground printing is not performed), an equivalent effect can be obtained. On the other hand, in the case where image data includes printing of a dot ground or color ground, when an image data portion for printing of the ground is not changed and only the density of pixels on the outer border of a character or a line drawing part to be printed is lowered and thinning is performed, a white blank (white boarder) occurs in a portion where the density is lowered, that is, in the outer periphery of the character.

### BRIEF SUMMARY OF THE INVENTION

According to an aspect of the invention, there is provided an image forming apparatus including an image processing unit that identifies an edge of a character and a line drawing with respect to an image formed based on inputted color image data and performs, only in a case where the edge exists on a white ground area in the image, thinning to lower an image density of a pixel on an outer border corresponding to the edge on the white ground area. The image processing unit of the image forming apparatus includes an image area identification unit that takes a density difference between adjacent pixels of the image data in pixel units and discriminates a character area and a line drawing area from an image area, a white ground determination unit that determines that a ground is a white ground in a case where a noted pixel in the image data has a density previously determined as a threshold value or higher, and when an average value of eight peripheral pixels surrounding the noted pixel is compared with the threshold value, the average value exceeds the threshold value, and a thinning unit that detects, for each color, the edge of the character and the line drawing detected from the character area and the line drawing area, performs the thinning to lower a color density of only a pixel on an outer border of the edge on the white ground to a level substantially equal to the white ground, and outputs an edge of the character and the line drawing on a ground other than the white ground without the thinning.

Besides, according to another aspect of the invention, there is provided an image thinning method including image area identification of taking a density difference between adjacent pixels of image data in pixel units, and discriminating a character area and a line drawing area from an image area, white ground determination of determining that a ground is a white ground in a case where a noted pixel in the image data has a density previously determined as a threshold value or higher, and when an average value of eight peripheral pixels surrounding the noted pixel is compared with the threshold value, the average value exceeds the threshold value, thinning of detecting, for each color, an edge of a character and a line drawing detected from the character area and the line drawing area, and lowering a color density of only a pixel on an outer border of the edge on the white ground to a level substantially equal to the white ground, non-thinning of outputting while a density of an edge of the character and the line drawing on a ground other than the white ground is not changed, and gradation processing of performing a dither processing on image data obtained by removing the character and the line drawing from the image data on which the thinning is performed and image data obtained by removing the character and the line drawing from the image data on which the thinning is not performed, wherein the edge of the character and the line drawing is identified with respect to an image formed based on color image data, and only in a case where the edge exists on the white ground area in the image, the thinning is performed to lower the image density of the pixel on the outer border corresponding to the edge on the white ground area.

### BRIEF DESCRIPTION OF THE SEVERAL VIEWS OF THE DRAWINGS

FIG. 1 is a view showing a conceptual structural example of an image recording apparatus (color MFP apparatus) made to have compound functions according to a first embodiment of the invention.

FIGS. 2A, 2B and 2C are views for explaining thinning in a color image.

FIG. 3 is a view showing a structural example for performing the thinning in an image processing unit of the embodiment.

FIG. 4 is a view showing a structural example of a thinning determination circuit shown in FIG. 3.

FIG. 5 is a flowchart for explaining a second embodiment.

FIGS. 6A, 6B, 6C, 6D and 6E are views for explaining detection directions of an edge of a character.

### DETAILED DESCRIPTION OF THE INVENTION

Hereinafter, embodiments of the invention will be described in detail with reference to the drawings.

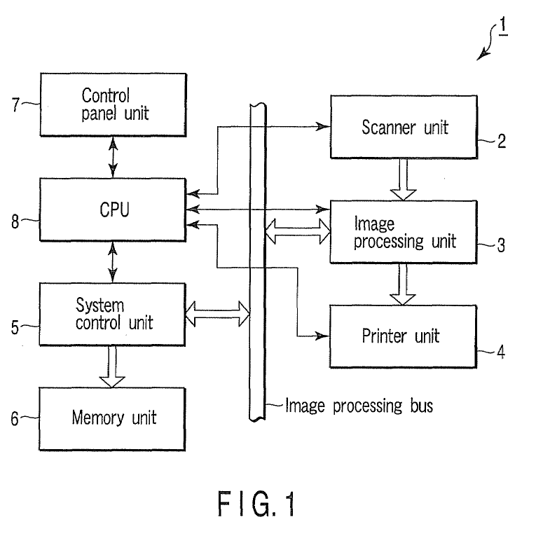

FIG. 1 shows a conceptual structural example of an image recording apparatus (color MFP apparatus) made to have compound functions according to a first embodiment of the invention.

The color MFP apparatus of the embodiment has at least a facsimile function, a copy function, a print function and a communication function. It is thinkable that output modes include color print output to a recording medium such as a recording sheet, communication output (including wired, wireless and optical communications) of color image data to a terminal such as a personal computer (PC), and network communication output to a terminal or another peripheral equipment through a network such as a LAN. It is thinkable that input modes include color image data inputted through each of the communications, color image data optically read from a recording sheet (original document) by a scanner unit, and input of color image data read from a detachable and attachable memory device. In the following explanation, a color MFP apparatus and color image data are simply called a MFP apparatus and image data.

Besides, a color image of the embodiment is an image in which a character and a photograph or a pattern are already integrated, for example, a pamphlet printed in color on a recording sheet or one photograph including a character, and is not image data in which character information and image information are individually managed. With respect to recording of a color image in the embodiment, a description will be made while using an example in which color (CMYK: Cyan, Magenta, Yellow, Key plate (Black)) printing is performed on a recording sheet. Of course, the color printing is not limited to the four colors, and more colors may be used. Incidentally, in contrast to a white ground area described below, an area not the white ground, for example, a dot ground area and a uniform ground area, is called a non-white ground area.

Besides, the white ground does not suggest that a recording medium, for example, a paper surface of a recording sheet is white. With respect to a ground in an image, a colored area (uniform ground), such as a photograph and a pattern (dot ground) formed (printed) around a character and a line drawing, is also called the ground. Accordingly, in the case where a character or a line drawing is formed on a photograph, the photograph becomes the dot ground. That is, the white ground is a portion where image data to be printed on a recording sheet does not exist (printing is not performed).

The MFP apparatus 1 shown in FIG. 1 includes a scanner unit 2 as input means for optically reading an image and generating color image data, an image processing unit 3 to perform an image processing including an after-mentioned emphasis processing, a printer unit 4 to print and output image data, a system controller unit 5 to instruct the image processing unit 3 to perform the image processing and to instruct a memory unit 6 to store an image, the memory unit 6 to store inputted image data and image data subjected to the image processing, a controller panel unit 7 to input user's instructions, and a central processing unit (CPU) 8 to control the whole component part.

In this structure, the scanner unit 2 optically reads an original document placed on a not-shown document table by a line sensor of three primary colors, performs A/D conversion and range correction, and generates RGB image data of red (Red), blue (Blue) and green (Green). Besides, the scanner unit 2 may include a recording sheet feed mechanism (not shown) to continuously feed a recording medium on which an image is printed to the document table.

Besides, the printer unit 4 includes a paper feed mechanism 11 to feed a recording sheet, a transport mechanism 12 to transport the recording sheet, a discharge (sorter) mechanism 13 to discharge the recorded recording sheet, and an image recording unit 14 to record an image. In the image recording unit 14, a recording head to record an image by using toner or ink (water-based or oil-based) is used. Besides, it is assumed that the central processing unit 8 is provided with a storage unit to store programs and data necessary for the image processing and the whole control.

The concept of the image processing by the image processing unit 3 in the embodiment will be described.

With respect to image data inputted to the image processing unit 3, a character edge and a line drawing edge are identified, and it is determined whether the identified edge exists on the white ground area or a ground area (dot ground area or uniform ground area (substantially uniform color)) having a color density. Specifically, an existing ground determination processing of determining (threshold processing) whether the density of a noted pixel exceeds a certain density is carried out to perform the determination of the ground.

Next, only in the case where the character edge and the line drawing edge exist on the white ground area, the image density of an image signal corresponding to an edge-identified color in the area is lowered. As an example, when the color is Cyan color, the density suggested by a Cyan signal is lowered, and when the color is BK color, the density suggested by a K signal or the density suggested by all color signals of CMY colors is lowered. On the other hand, the case in which an edge is in an area other than the white ground area, that is, a character or a line drawing existing in the dot ground area or the color ground area is not subjected to the processing of lowering the image density.

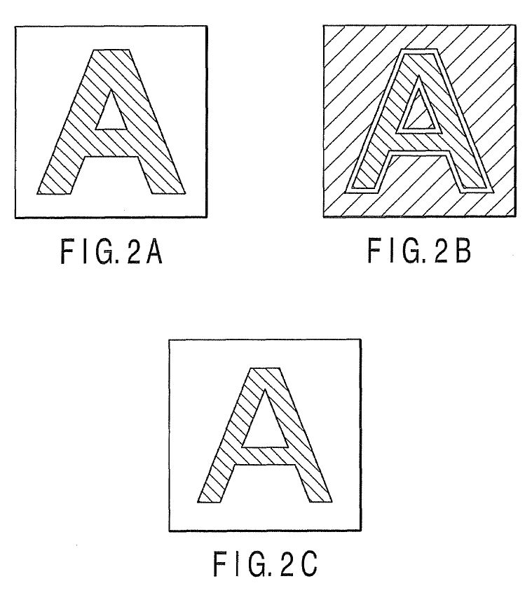

With respect to the thinning, a character of “A” as shown in FIG. 2A is used as an example. The thinning of a color image in this embodiment is such that with respect to an edge of a character and/or a line drawing, the density of only a pixel on an outer border thereof is lowered to a level comparable to that of the ground, and the thinning is realized. As shown in FIG. 2C, in the case where the ground is determined to be the white ground, the thinning of the character and/or line drawing is performed. On the other hand, when the character on the ground of the dot area (here, indicated by hatching) as shown in FIG. 2B is thinned, a white boarder (white blank) is generated. Accordingly, in the case where the ground is the dot ground area or the uniform area, the thinning is not performed.

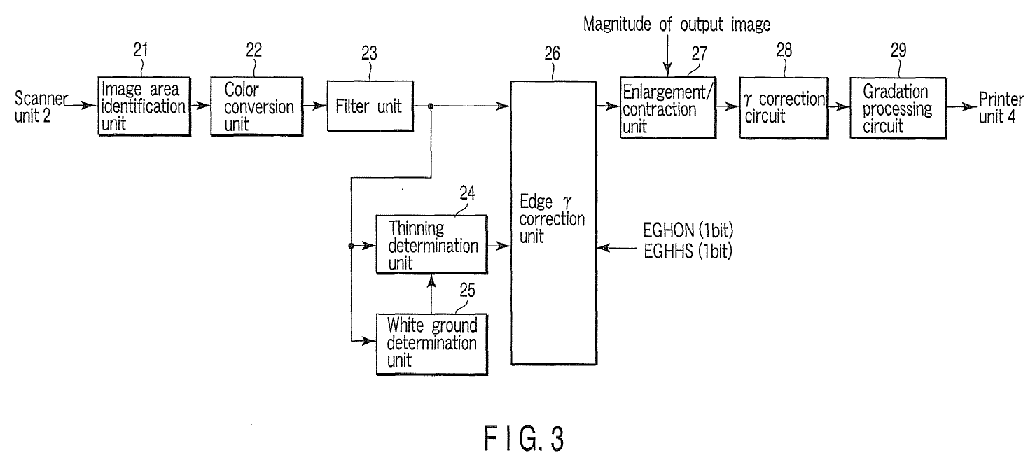

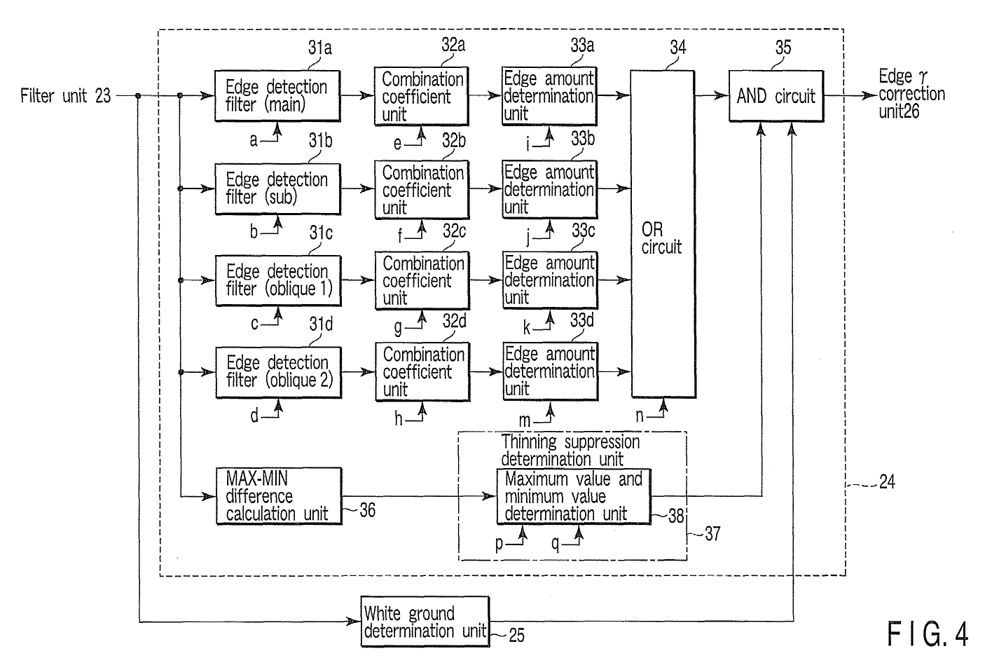

FIG. 3 shows a structural example for performing the thinning in the image processing unit 3 of the embodiment, FIG. 4 shows a structural example of a thinning determination circuit shown in FIG. 3, and a description will be made. In the thinning, (1) thinning determination processing, (2) white ground determination processing and (3) edge γ correction processing are roughly performed.

The image processing unit 3 shown in FIG. 3 includes an image area identification unit 21, a color conversion unit 22, a filter unit 23, a thinning determination unit 24, a white ground determination unit 25, an edge γ correction unit 26, an enlargement and contraction unit 27, a γ correction circuit 28 and a gradation processing circuit 29. Incidentally, in this embodiment, only component parts relating to the gist are shown, and other processing circuits necessary for normal image processing are also included.

Besides, the filter unit 23 includes a low-pass filter circuit, a range correction circuit, a line delay circuit, a high-pass filter circuit and a multiplication and addition circuit.

In this structure, with respect to an image formed on a recording sheet, the white ground determination unit 25 performs determination of a white ground area and a dot area (or a uniform area), and the edge γ correction unit 26 substantially performs thinning of an edge of a character or a line drawing.

RGB image data generated by the scanner unit 2 is inputted to the image area identification unit 21 and the color conversion unit 22. The image area identification unit 21 is for identifying the kind of an image, takes a density different between adjacent pixels of the RGB image data in pixel units, and determines that an area is a character area and a line drawing area when the density difference exceeds a threshold value, and determines that an area is an image area such as a photograph when it is the threshold value or less. The image area identification unit 21 can also discriminate between a character area (and a line drawing area) and an image area with respect to CMYK image data. The color conversion unit 21 converts the RGB image data into CMYK image data as component colors of printing colors in pixel units.

The filter unit 23 puts a spatial filter on the CMYK image data by taking the weighted linear sum of pixel values in an image area around a noted pixel for each color data. This is for improving, for example, the sharpness of an image by raising the gain of a specific frequency band. However, in a photographic area formed of dots, when the frequency of the dot is emphasized, the occurrence of moire is caused. Then, the filter characteristic is changed according to the result of the image area identification. Incidentally, in the case where the CMYK image data is CMY image data, in order to raise the reproducibility of a black character or a shadow part, black component (K) image data is generated from the CMY image data outputted from the filter unit 23. An after-mentioned black generation unit (not shown) is provided to generate the K image data.

The white ground determination unit 25 performs determination (threshold processing) based on the density of a noted pixel in the image data. In the white ground determination, in the case where the noted pixel has a certain density or higher, and when an average value of eight peripheral pixels is compared with a threshold value, the average value exceeds the threshold value (that is, the peripheral density exceeds the density of the previously determined threshold value), it is determined that the ground is a color uniform ground or a dot ground, and is not the white ground. Here, as the threshold value, a register: noted pixel density threshold value (TH1) 8 bits, peripheral density threshold value (TH2) 8 bits is adopted. The white ground determination unit 25 outputs the determination result that the ground is not the white ground to an after-mentioned AND circuit 35. Even in the case where the determination result of the thinning determination unit 24 is an edge, it is corrected to be a non-edge. By the correction to the non-edge, the thinning is not performed.

The edge γ correction unit 26 lowers the density of the edge of the character or line part to a predetermined density in the case where the ground is the white ground, that is, performs the thinning. In accordance with the thinning determination value of the thinning determination unit 24 described later, with respect to the edge pixel, γ correction is performed using an edge γ correction table (8 bits*256) in the edge 7 correction unit 26. By changing the set value of the edge 7 correction table, the extent of lowering of the density, that is, the extend of thinning can be adjusted.

On the other hand, the thinning is not performed for the non-edge pixel. Besides, in the case where an evaluation mode is selected, an identified image with image data FFh of an edge pixel and image data 00 h of a non-edge pixel is outputted. A value outside of the image area is 00 h and is processed.

The enlargement and contraction unit 27 adjusts the size of an output image so that print output is performed with an instructed image size. In order to absorb a difference between the gradation characteristic of an image signal and the gradation characteristic of image formation in the printer unit 4, the γ correction circuit 28 uses a conversion table for each color to convert the image signal value into toner amount or ink amount. Here, with respect to a character and line drawing portion, in order to raise the sharpness, the conversion table to more intensify the contrast is used.

In the case where the number of gradations of an image printed and outputted by the printer unit 4 is smaller than the number of gradations of image data, the gradation processing unit 29 performs a dither processing for apparently performing gradation reproduction (area modulation) by using a specified number of pixels. For example, in the case where image data of 256 gradations is outputted by the printer unit with 2 gradations, when 16×16 pixels are used, 256 gradations (actually, 257 gradations) can be reproduced theoretically. However, with respect to the character and line drawing portion, when the area modulation is simply performed, the edge structure is broken. Then, in order to keep the edge structure, a pixel determined to be the picture character and line drawing by the image area identification unit 21 is simply binarized, and the gradation reproduction is performed by using only pixels other than that. In the printer unit 4, the toner of the amount based on the CMYK image data outputted from the image processing unit 3 is transferred from the recording head to the recording sheet, so that an image is formed. Alternatively, in the printer unit 4, the ink of the amount based on the CMYK image data outputted from the image processing unit 3 is discharged from the recording head to the recording sheet, so that an image is formed.

FIG. 4 shows a structural example of the thinning determination unit 24 shown in FIG. 3 and a description will be made.

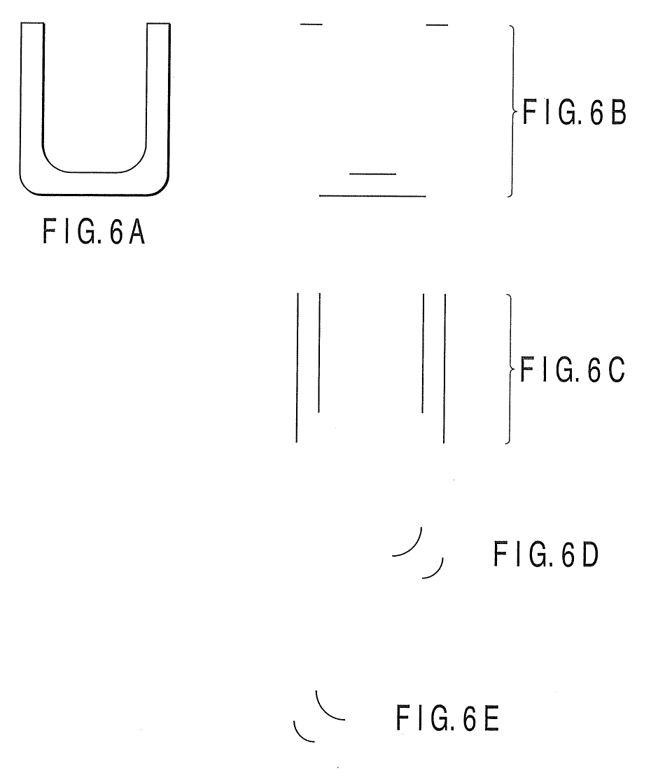

The thinning determination unit 24 of the embodiment detects edges in four directions as shown in FIGS. 6A to 6E. In this embodiment, for example, FIG. 6A shows an example in which a character is, for example, U. Edges are detected in four directions, that is, the horizontal direction (main direction) of FIG. 6B, the vertical direction (sub-direction) of FIG. 6C, right-upward oblique direction (oblique 1) of FIG. 6D, and left-upward oblique direction (oblique 2) of FIG. 6E. Of course, the detection direction may be further increased. Although the oblique 1 and the oblique 2 cross each other, it is not always necessary that they are orthogonal to each other, and the inclination of those can be suitably set.

The thinning determination unit 24 includes edge detection filters 31a, 31b, 31c and 31d, combination coefficient units 32a, 32b, 32c and 32d, edge amount determination units 33a, 33b, 33c and 33d, an OR circuit 34, an AND circuit 35, a MAX-MIN difference calculation unit 36, and a thinning suppression determination unit 37. Among these, the edge detection filters, the combination coefficient units, the edge amount determination units, and the OR circuit 34 constitute an edge detection unit. The thinning suppression determination unit 37 includes a maximum value and minimum value determination unit 38. The respective component parts will be described.

The edge detection filters 31a, 31b, 31c and 31d include 3×3 Sobel filters, perform calculation in the foregoing four directions individually, and output four filter calculated values. Each of these filter calculated values is expressed by 13 bits (among them, a sign portion has one bit).

The combination coefficient unit 32a, 32b, 32c, 32d multiplies the filter calculated value obtained by the edge detection filter by a coefficient (integer part of 1 bit, decimal part of 4 bits) and adjusts the magnitude of the calculated value (it becomes, for example, 18 bits).

Each of the edge amount determination units 33a, 33b, 33c and 33d takes an absolute value after the combination calculation (it becomes, for example, 17 bits), and a value (it becomes, for example, 13 bits) obtained by discarding the decimal part of 4 bits is made an edge amount. This edge amount is compared with a predetermined threshold value (11 bits), and when it is larger than the threshold value, the determination of the edge is made. The determination result (1 bit) is set such that the edge is “1”, and the non-edge is “0”. Further, the OR of the determination values in the four directions is made the edge determination value (1 bit) of the noted pixel.

Further, the MAX-MIN difference calculation unit 36 obtains a maximum value and a minimum value among 3×3 pixels of the noted pixel and the eight peripheral pixels, and calculates a difference value therebetween (8 bits).

The thinning suppression determination unit 37 compares the difference value obtained by the MAX-MIN difference calculation unit 36 with the threshold value (8 bits). When the difference value is smaller than the threshold value in this comparison, it is determined that MTF (Modulation Transfer Function) is low or it is not the edge part, and the pixel is determined to be a thinning suppression object (or non-edge) pixel. By this determination, thinning is not performed. Incidentally, the determination result (1 bit) is made such that the suppression object pixel is “0” and the suppression non-object pixel is “1”. The threshold value can be changed to an arbitrary value.

The AND circuit 35 takes the AND of three determination results, that is, the edge determination value (output of 1 bit of the OR circuit) by the edge amount determination units 33a, 33b, 33c and 33d, the determination result (1 bit) by the thinning suppression object determination, and the determination result (1 bit) of the white ground by the white ground determination unit 25, and outputs the final thinning determination value (1 bit: edge 1, non-edge 0).

Incidentally, in this embodiment, in FIG. 3 and FIG. 4, the register, the coefficient and the threshold value are set as follows.

(1) HTSL . . . initial value 00h This is a register to set effectiveness and ineffectiveness of the edge amount determination result and the thinning suppression determination result. In the case where the ineffectiveness is set, the determination result is not reflected on the thinning operation.

(b0) main scanning direction edge amount determination result effectiveness (1)/ineffectiveness (0)

(b1) sub-scanning direction edge amount determination result effectiveness (1)/ineffectiveness (0)

(b2) oblique direction 1 edge amount determination result effectiveness (1)/ineffectiveness (0)

(b3) oblique direction 2 edge amount determination result effectiveness (1)/ineffectiveness (0)

(b4) thinning suppression determination unit maximum value-minimum value determination result effectiveness (1)/ineffectiveness (0)

(2) EGHON, EGHHS, EGHCSL . . . initial value 00h

These are registers to perform selection of a processing method of image data in the edge γ correction unit 26 and control of the edge correction γ table.

EGHON (b0) edge γ correction effectiveness [thinning is performed] (1)/ineffectiveness (0)

EGHHS (b1) edge γ correction operation selection (0: normal operation, 1: evaluation mode)

EGHCSL (b4) edge γ correction CPU access permission (0: normal copy, 1: CPU access)

Incidentally, the effectiveness (1) of the edge γ correction suggests that the thinning is performed, and the ineffectiveness (0) suggests that the thinning is not performed.

As the processing method of image data, there are following three kinds of methods.

edge γ correction (default) EGHHS (b1) . . . (0), EGHON (b0) . . . (1)

no edge γ correction (thinning is ineffective) EGHHS (b1) . . . (0), EGHON (b0) . . . (0)

evaluation mode (identification image output) EGHHS (b1) . . . (1), EGHON (b0) . . . (0/1)(don't care)

(3) SREG0-3[A,B] . . . initial value 11h

SREG0-3[A,B] is a register to perform setting of coefficients of the edge detection filters in the four directions. For example, SREG0A indicates A0 of the main scanning filter. Each coefficient has 2 bits (an actually set value has 3 bits including a sign). A coefficient A is (b1,b0) and a coefficient B is (b4).

| main scanning | −A0 | −B0 | −A0 |
|---|---|---|---|
| SREG0A | 0 | 0 | 0 |
| SREG0B | A0 | B0 | A0 |
| sub-scanning | −A | 0 | A1 |
| SREG1A | −B1 | 0 | B1 |
| SREG1B | −A1 | 0 | A1 |
| oblique 1 | −B2 | −A2 | 0 |
| SREG2A | −A2 | 0 | A2 |
| SREG2B | 0 | A2 | B2 |
| oblique 2 | 0 | −A3 | −B3 |
| SREG3A | A3 | 0 | −A3 |
| SREG3B | B3 | A3 | 0 |

Incidentally, it is assumed that in the edge detection filters 31a, 31b, 31c and 31d shown in FIG. 4, the coefficient a is given by SREG0A 2 bits, SREG0B 2 bits, the coefficient b is given by SREG1A 2 bits, SREG1B 2 bits, the coefficient c is given by SREG2A 2 bits, SREG2B 2 bits, and the coefficient d is given by SREG1A 2 bits, SREG1B 2 bits.

(4) KREG[0-3] . . . initial value 10h

This is a register to perform setting of coefficients multiplied to the edge detection filter calculated values in the four directions. Here, the integer part has 1 bit, the decimal part has 4 bits, and the range of value is [0-1.9375](dec).

It is assumed that in the combination coefficient units 32a, 32b, 32c and 32d shown in FIG. 4, the coefficient e is given by KREG0 5 bits, the coefficient f is given by KREG1 5 bits, the coefficient g is given by KREG2 5 bits, and the coefficient h is given by KREG3 5 bits. b0, b1, b2, b3 . . . decimal part, b4 . . . integer part, b5, b6, b7 . . . no setting.

(5) STHR[1-3] . . . initial value high-order 00h, low-order 80h

This is a register to set edge amount determination threshold values in the four directions.

The integer part has 11 bits (high-order 3 bits, low-order 8 bits). The range of value is [0-2047](dec).

Further, it is assumed that in the edge amount determination units 33a, 33b, 33c and 33d, the threshold value i is given by STHR0 11 bits, the threshold value j is given by STHR1 11 bits, the threshold value k is given by STHR2 11 bits, and the threshold value m is given by STHR3 11 bits. The coefficient n of the OR circuit is given by HTSI (3:0)4 bits. The coefficient p of the maximum value and minimum value determination unit 38 is given by HTSI (4) 1 bit, and the threshold value q is given by CTHR 8 bits.

(6) CTHR . . . initial value 46 h

This is a register to set the maximum value-minimum value determination threshold value of thinning suppression determination.

In this embodiment, the value has 8 bits. The range of value is [0-255](dec).

(7) SVR[0-255] . . . initial value XXh

This is a register to set the edge γ correction table value. In this embodiment, it has 8 bits.

In this embodiment, although the description has been made using the CMYK image data, in the case of CMY image data, there is provided a black generation unit (not shown) to generate black component (K) image data from the CMY image data outputted from the filter unit 23. As the processing of the black generation unit, there is known a method in which as in the following expression (1), what is obtained by multiplying the minimum value of CMY three colors by a specified value Z (0≦z≦1) is made the value of K, and a value obtained by subtracting K from each value of CMY is made a value of new CMY.

K=Z×min(C,M,Y)C′=C−KM=M−KY′=Y−K expression (1)

Besides, with respect to a black character and black line drawing portion in the white ground area, a processing is performed in which as in the following expression (2), an average value of CMY three colors is made a value of K, and all values of CMY are made “0”.

K=(C+M+Y)/3C′=M′=Y′=0 expression (2)

As described before, in the case where the related art thinning is performed on the character or line drawing recorded on the dot ground area or the color ground area, there is a possibility that a white blank (white boarder) occurs around the character.

In this embodiment, the edge of the character or the line drawing in the image data is identified, and it is determined whether the identified edge exists on the white ground area or the ground (dot or uniform ground) area having a color density. Only in the case where the edge is identified to be the edge of the character and line drawing recorded on the white ground, the image density thereof is lowered, so that the thinning of the character and line drawing is performed. In the case of the ground having the color density, the processing of reducing the image density is not performed on the edge of the character or line drawing, and print output is performed. Accordingly, the occurrence of the white boarder (white blank) to the color original document is suppressed, and the amount of consumption of toner or ink at the time of image printing can be reduced.

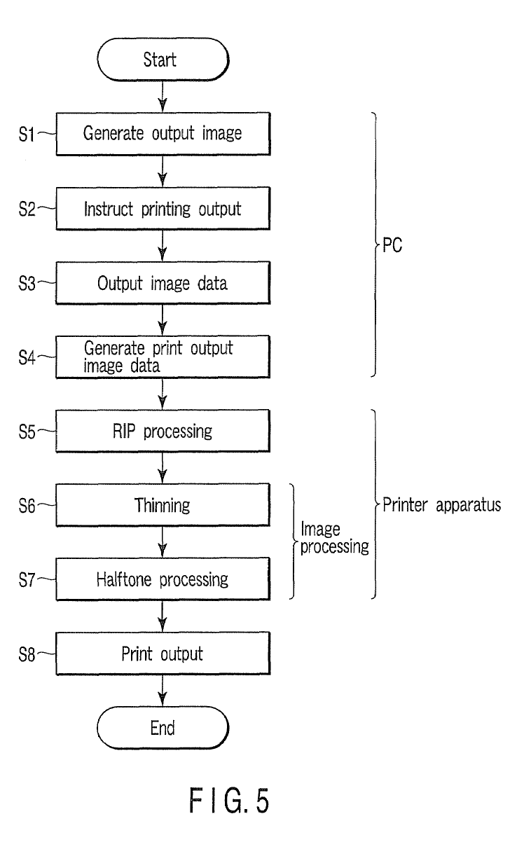

Next, a second embodiment will be described with reference to a flowchart shown in FIG. 5.

This embodiment is an example in which with respect to the foregoing MFP apparatus, a document and an image (photograph) are generated by an application running on an external terminal (PC), and printing is performed. The structure of this embodiment is the same as that of the first embodiment, and the same reference numerals are given and their explanation will be omitted here.

The external terminal generates, from a document or an image (photograph) to be expanded, RGB image data (electronic image data) to be printed and outputted (step S1). The external terminal instructs the MFP apparatus to perform print output (step S2). Next, the RGB image data is outputted using a known system (for example, PDL·VIDEO_IF) by a driver such as a printer driver, and is stored in a memory unit 6 of the MFP apparatus 1 (step S3).

The MFP apparatus 1 uses image relevant setting contained in PDL (Page Description Language) of the image data sent from the terminal and a drawing command, and generates CMYK image data in an image processing unit 3 of the MFP apparatus 1 (step S4). Further, the CMYK image data is subjected to RIP (Raster Image Processor) processing by the image processing unit 3 (step S5). Thereafter, the foregoing determination of the ground in the image data is performed, and when the ground is the white ground, thinning is performed (step S6), and next, halftone processing is performed (step S7), and image data for printing is generated. After these image processings, the image data is sent to an image recording unit 14, and an image is formed on a recording sheet fed by a paper feed mechanism 11 (step S8).

Incidentally, in the structure of the MFP apparatus 1 of the embodiment, although the image processing unit 3 performs the RIP processing, the thinning and the halftone processing, the structure may be such that an RIP processing unit performs the RIP processing, and a controller image processing unit performs the thinning and halftone processing. Besides, the image recording unit (print engine) 14 may be a recording head to perform image formation with toner or to perform image formation with ink. Besides, although the description has been given to the MFP apparatus, a printer apparatus may be used.

According to this embodiment, similarly to the first embodiment in which the image data is optically read, even in the case where the image data is directly inputted, the effect of reducing the amount of consumption of toner or ink can be obtained.

Besides, in the case where the printer apparatus is used for print output, the thinning determination unit and the edge gamma correction processing unit are entered in the image data path of 8-bit RIP to realize. Further, thinning intensity can be adjusted for each color of image data. Besides, in the thinning determination, in addition to the case where a color signal is used, a mode may be adopted in which the thinning determination is performed using an achromatic image signal obtained from a color signal. With respect to a GUI (Graphical User Interface), while the surface screen is seen, for example, the intensity level (line is made thin or tick, thinning intensity is adjusted for each color, default changed image data is stored, a user performs customization, and the like) can also be adjusted by the control panel.

What is claimed is:

1. An image forming apparatus comprising:
an image processing unit that identifies an edge of a character and a line drawing with respect to an image formed based on inputted color image data and performs, only in a case where the edge exists on a white ground area in the image, thinning to lower an image density of a pixel on an outer border corresponding to the edge on the white ground area.

2. The image forming apparatus according to claim 1, wherein the image processing unit includes:
an image area identification unit that takes a density difference between adjacent pixels of the image data in pixel units and discriminates a character area and a line drawing area from an image area;
a white ground determination unit that determines that a ground is a white ground in a case where a noted pixel in the image data has a density previously determined as a threshold value or higher, and when an average value of eight peripheral pixels surrounding the noted pixel is compared with the threshold value, the average value exceeds the threshold value; and
a thinning unit that detects, for each color, the edge of the character and the line drawing detected from the character area and the line drawing area, performs the thinning to lower a color density of only a pixel on an outer border of the edge on the white ground to a level substantially equal to the white ground, and outputs the edge of the character and the line drawing on a ground other than the white ground without the thinning.

3. The image forming apparatus according to claim 2, wherein the thinning unit includes:
an edge detection unit that detects edges in at least four directions crossing each other with respect to the character and the line drawing in the character area and the line drawing area;
a difference calculation unit that obtains a maximum value and a minimum value among a noted pixel of a pixel of the detected edges and eight adjacent pixels in its periphery, and calculates a difference value therebetween;
a thinning suppression determination unit that compares the difference value with a previously determined threshold value, and determines that the pixel is a pixel of thinning suppression object when the difference value is smaller than the threshold value; and
an edge γ correction unit that performs an edge γ correction on only the edge pixel on the outer border of the character and the line drawing when thinning is confirmed based on the edge detected by the edge detection unit, determination of thinning execution by the thinning suppression determination unit and determination of the white ground by the white ground determination unit, performs the thinning to lower the density to a previously determined density for each color and performs output.

4. The image forming apparatus according to claim 3, wherein the thinning suppression determination unit includes a table in which plural desired values selectable as the threshold value are set.

5. The image forming apparatus according to claim 4, further comprising a control panel to input the desired values as the threshold value to the table of the thinning suppression determination unit.

6. The image forming apparatus according to claim 3, wherein the edge γ correction unit includes a table in which plural desired values selectable as a correction value for performing the edge γ correction are set, and adjusts a density lowering degree in the thinning for each color.

7. The image forming apparatus according to claim 2, further comprising a table in which plural desired values selectable as the threshold value are set.

8. The image forming apparatus according to claim 7, further comprising a control panel to input the desired values as the threshold value to the table of the thinning suppression determination unit.

9. The image forming apparatus according to claim 3, wherein the edge detection unit includes:
an edge detection filter that outputs the edge as a filter calculated value individually in at least four directions crossing each other with respect to the character and the line drawing in the character area and the line drawing area;
a combination coefficient unit that multiplies the filter calculated value obtained by the edge detection filter by a previously determined coefficient and adjusts a magnitude of the calculated value;
an edge amount determination unit that calculates an edge amount based on the adjusted calculated value, compares it with a previously determined threshold value, and makes determination of an edge when the edge amount is larger than the threshold value; and
a summation unit that sums determination results in the four directions in the character and the line drawing and outputs it as an edge determination result of the noted pixel.

10. The image forming apparatus according to claim 3, further comprising a gradation processing unit configured to perform a dither processing on image data on which the thinning is performed and which is other than the character and the line drawing, and on image data on which the thinning is not performed due to non-white ground determination and which is other than the character and the line drawing.

11. An image forming apparatus comprising:
an image generation unit configured to optically read an image and to generate color image data;
a storage unit configured to store the image data generated by the image generation unit and color image data inputted from outside;
an image area identification unit configured to identify a kind of a formed image based on a density difference between adjacent pixels in pixel units with respect to the image data read out from the storage unit;
a white ground determination unit configured to determine that an area is a white ground area in a case where with respect to the image data, a noted pixel has a density previously determined as a threshold value or higher, and when an average value of eight peripheral pixels surrounding the noted pixel is compared with the threshold value, the average value exceeds the threshold value, and to determine an area other than an area where the average is the threshold value or lower to be a non-white ground area;
an edge detection unit configured to detect edges in plural directions with respect to a character and a line drawing identified by the image area identification unit;
a thinning unit configured to lower an image density of a pixel on an outer border corresponding to the edge on the white ground area only in a case where the edge exists on the white ground area; and
an image formation unit configured to form an image based on image data on which thinning is performed by the thinning unit and based on image data on which the thinning is not performed due to determination of the non-white ground area.

12. The image forming apparatus according to claim 2, wherein the white ground determination unit determines that image data formed into a photograph or a picture pattern is a dot ground, uniform colored image data containing one color or a mixed color is a uniform ground, and both are a non-white ground.

13. An image thinning method, comprising:
identifying an edge of a character and a line drawing with respect to an image formed based on color image data; and
performing, only in a case where the edge exists on a white ground area in the image, thinning to lower an image density of a pixel on an outer border corresponding to the edge on the white ground area.

14. The image thinning method according to claim 1, further comprising:
image area identification of taking a density difference between adjacent pixels of the image data in pixel units, and discriminating a character area and a line drawing area from an image area;
white ground determination of determining that a ground is a white ground in a case where a noted pixel in the image data has a density previously determined as a threshold value or higher, and when an average value of eight peripheral pixels surrounding the noted pixel is compared with the threshold value, the average value exceeds the threshold value;
thinning of detecting, for each color, an edge of a character and a line drawing detected from the character area and the line drawing area, and lowing a color density of only a pixel on an outer border of the edge on the white ground to a level substantially equal to the white ground;
non-thinning of outputting while a density of an edge of the character and the line drawing on a ground other than the white ground is not changed; and
gradation processing of performing a dither processing on image data obtained by removing the character and the line drawing from the image data on which the thinning is performed and image data obtained by removing the character and the line drawing from the image data on which the thinning is not performed.
